(19) United States
(12) Patent Application Publication
(10) Pub. No.: US 2024/0154377 A1
(43) Pub. Date: May 9, 2024

(54) PULSE MODIFICATION APPARATUS COMPRISING A PASSIVE CONVERSION DEVICE FOR COMPENSATING FOR AMBIENT INFLUENCES

(71) Applicant: TRUMPF Laser GmbH, Schramberg (DE)

(72) Inventor: Andreas Enzmann, Villingen-Schwenningen (DE)

(21) Appl. No.: 18/408,631

(22) Filed: Jan. 10, 2024

Related U.S. Application Data
(63) Continuation of application No. PCT/EP2022/065251, filed on Jun. 3, 2022.

(30) Foreign Application Priority Data
Jul. 12, 2021 (DE) 10 2021 207 332.8

(51) Int. Cl. H01S 3/00; G02B 26/04

(52) U.S. Cl. CPC H01S 3/0057; G02B 26/04; H01S 3/0014

(57) ABSTRACT

A pulse modification apparatus for dispersive stretching or compression of laser pulses includes at least one dispersive optical element for angle separation and combination of spectral components of laser pulses, an actuator for setting a dispersion of the pulse modification device by influencing the spectral components of the laser pulses, at least one passive sensor having an output variable dependent on at least one ambient parameter, and a passive converter for converting a change of the output variable of the at least one passive sensor into a manipulated variable change of the actuator in order to compensate for an alteration of the dispersion of the pulse modification apparatus resulted from an alteration of the at least one ambient parameter.

### CROSS REFERENCE TO RELATED APPLICATIONS

This application is a continuation of International Application No. PCT/EP2022/065251 (WO 2023/285028 A1), filed on Jun. 3, 2022, and claims benefit to German Patent Application No. DE 10 2021 207 332.8, filed on Jul. 12, 2021. The aforementioned applications are hereby incorporated by reference herein.

### FIELD

Embodiments of the present invention relate to a pulse modification apparatus in the form of a pulse stretching apparatus for dispersive stretching of laser pulses or a pulse compression apparatus for dispersive compression of laser pulses. Embodiments of the present invention further relate to a chirped pulse amplification system.

### BACKGROUND

Laser pulses, in particular ultrashort laser pulses, i.e. laser pulses having pulse durations in the picoseconds range or shorter, find application in numerous technological fields, for example in material processing including laser welding and laser cutting. One important variable in the description of laser pulses is the phase of the electric field of the laser pulses in the frequency domain, the so-called spectral phase. A distinction can thus be drawn between unchirped laser pulses, which have a spectral phase which is constant or linearly dependent on frequency, and chirped laser pulses, the spectral phase of which has a more complex frequency dependence. Put simply, in a chirped laser pulse, specific spectral components, for example lower-frequency spectral components, lead other spectral components, for example higher-frequency spectral components. Unchirped laser pulses are distinguished by a minimum pulse duration for a given spectral width.

The properties of laser pulses can be influenced in a targeted manner by means of apparatuses which have different effects on the individual spectral components of the laser pulses, i.e. which are dispersive, in particular by means of apparatuses which alter the spectral phase. High pulse qualities, short pulse durations and high pulse intensities are generally desired. Pulse stretching apparatuses for dispersive stretching of laser pulses and pulse compression apparatuses for dispersive compression of laser pulses are of particular importance. Unchirped and chirped laser pulses can be temporally stretched by means of pulse stretching apparatuses. The resulting temporally stretched laser pulses are then chirped or more intensely chirped. Chirped laser pulses can be temporally compressed by means of pulse compression apparatuses. The resulting temporally compressed laser pulses are then less intensely chirped or unchirped.

Pulse stretching and pulse compression apparatuses are often used in combination with one another. By way of example, at least one pulse stretching apparatus, at least one pulse compression apparatus and a pulse amplifying device are integrated in a so-called chirped pulse amplification system. In combination with a seed laser, a chirped pulse amplification system serves for generating ultrashort laser pulses having very high pulse intensities. In this case, laser pulses of the seed laser, for example a fibre laser, are first temporally stretched by means of the at least one pulse stretching apparatus. The stretched laser pulses are subsequently amplified in the amplifying device, for example in a fibre amplifier. After amplification, the amplified laser pulses are temporally compressed again by means of the at least one pulse compression apparatus. Without the temporal stretching before amplification, owing to the high intensity and attendant non-linear effects, the amplifier medium of the amplifying device would be damaged or destroyed and the pulse properties would be impaired. Further details concerning the set-up of ultrashort pulse lasers with a seed laser and a chirped pulse amplification system may be found for example in the article “Pulsed Lasers for Industrial Applications” by F. Jansen et al., Laser Technik Journal 2, 46 (2018).

Pulse stretching and pulse compression apparatuses are often set up as free-space devices, which means that the laser pulses or the spectral components thereof propagate at least partly through air or some other gas atmosphere. This is advantageous if the intention is for high intensities to occur and/or for high stretching factors to be attained. This design includes grating and prism stretchers, or grating and prism compressors, in which at least one grating or prism, respectively, serves for separating and combining the individual spectral components. The separated spectral components have different propagation times in the stretchers or compressors before they are combined again, which leads to the desired temporal stretching or compression, respectively.

The dispersion of a pulse stretching or pulse compression apparatus can be described mathematically by way of the accumulated spectral phase, φ(ω), of the laser pulses during propagation through the pulse stretching or pulse compression apparatus. In this case, the pulse stretching or pulse compression apparatus is typically characterized by way of the coefficients, βᵢ, of a Taylor expansion

$$φ ( ω ) = {β}_{0} + {β}_{1} ( ω - {ω}_{0} ) + \frac{{β}_{2}}{2} {( ω - {ω}_{0} )}^{2} + \frac{{β}_{3}}{6} {( ω - {ω}_{0} )}^{3} + …$$

at the angular frequency, co, about the central frequency, ω₀, of the laser pulses. What is of importance in particular is the group delay dispersion, β₂, which describes the temporal divergence or convergence of the lowest-order laser pulses. In the case of highly dispersive pulse stretching and pulse compression apparatuses, however, the higher orders, in particular the third-order dispersion, β₃, also play a part.

The prior art furthermore describes devices for setting the dispersion of a pulse stretching and/or pulse compression apparatus or of an apparatus comprising a pulse stretching and/or a pulse compression apparatus. An accurate setting of the dispersion is important in order to attain the highest possible pulse quality, in particular the shortest possible pulse duration. In particular, alterations in the surroundings that affect the pulse stretching and/or pulse compression apparatus can thus be compensated for as well. In this context, the dispersion is set on the basis of a measurement of at least one pulse property of the laser pulses.

In this regard, EP 3 578 287 A1 describes a laser system comprising a laser pulse source and a dispersion adjusting unit for pulse stretching or pulse compression of laser pulses with an arrangement comprising at least one dispersive element for generating angular dispersion and an optical unit arranged in the angular dispersion region. The optical unit comprises a plane-parallel optical plate that transmits the laser pulses and causes an entrance-angle-dependent parallel offset of the individual spectral components of the laser pulses. A rotation of the optical plate influences the dispersion properties of the dispersion adjusting unit. In particular, a rotation of the optical plate makes it possible to set the pulse duration of the laser pulses in an output beam of the laser system. In one example, the laser system furthermore comprises a pulse duration measuring apparatus and a control unit. The pulse duration measuring apparatus serves for outputting a pulse-duration-dependent measurement signal to the control unit. The control unit serves for controlling an angle setting apparatus for setting an angular position of the optical plate depending on the pulse duration measurement.

U.S. Pat. No. 7,822,347 furthermore describes a chirped pulse amplification system comprising a pulse generator, a pulse stretcher, a pulse amplifier and a pulse compressor, and also a setting element and a pulse measuring device. The setting element is suitable for setting the group velocity dispersion of the chirped pulse amplification system and for regulating the pulse duration of the compressed pulses. By means of the setting element, either the dispersion of one of the elements already present in the chirped pulse amplification system, for example the pulse stretcher or the pulse compressor, can be set or there is an additional dispersive element in the chirped pulse amplification system. The pulse measuring device is suitable for measuring at least one pulse property of the compressed pulses for example by way of multiphoton detection, an autocorrelator or by way of a FROG (Frequency-Resolved Optical Gating) system. The setting element is furthermore configured to react to an output signal of the pulse measuring device. In one example, the setting element serves to compensate for alterations of the dispersion which are attributable to alterations in the surroundings or the optical path length of free-space elements. In further examples, the setting element is configured to apply a temperature gradient or a strain gradient to a fibre Bragg grating.

In general, however, known pulse measuring devices, angle setting apparatuses and control units, including those mentioned above, have a relatively complex set-up and are comparatively expensive.

### SUMMARY

Embodiments of the present invention provide a pulse modification apparatus for dispersive stretching or compression of laser pulses. The pulse modification apparatus includes at least one dispersive optical element for angle separation and combination of spectral components of laser pulses, an actuator for setting a dispersion of the pulse modification device by influencing the spectral components of the laser pulses, at least one passive sensor having an output variable dependent on at least one ambient parameter, and a passive converter for converting a change of the output variable of the at least one passive sensor into a manipulated variable change of the actuator in order to compensate for an alteration of the dispersion of the pulse modification apparatus resulted from an alteration of the at least one ambient parameter.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a and FIG. 1b show schematic illustrations of a pulse modification apparatus in the form of a pulse compression apparatus having two dispersive optical elements, an actuating device, comprising a plane-parallel transmissive optical element, a sensor element and a passive conversion device, according to some embodiments;

FIG. 2a, FIG. 2b and FIG. 2c show schematic illustrations of variants of the passive conversion device shown in FIG. 1 and FIG. 1b, according to some embodiments;

FIG. 3 shows a schematic illustration of an actuating device having a double-wedge arrangement, according to some embodiments; and

FIG. 4 shows a simplified schematic illustration of a chirped pulse amplification system for amplifying laser pulses comprising a pulse compression apparatus which is a pulse modification apparatus according to embodiments of the invention.

### DETAILED DESCRIPTION

Embodiments of the invention provide a pulse modification apparatus in the form of a pulse stretching apparatus or a pulse compression apparatus in which the emerging laser pulses have constant pulse properties independently of at least one ambient parameter and which has at the same time a simple and cost-effective set-up.

In accordance with a first aspect, a pulse modification apparatus in the form of a pulse stretching apparatus for dispersive stretching of laser pulses or a pulse compression apparatus for dispersive compression of laser pulses comprises at least one dispersive optical element for angle separation and combination of spectral components of the laser pulses, and an actuating device for setting the dispersion of the pulse modification device by way of influencing the spectral components, and also comprising at least one passive sensor element having an output variable dependent on at least one ambient parameter, and a passive conversion device for converting an output variable change of the at least one passive sensor element into a manipulated variable change of the actuating device in order to compensate for an alteration of the dispersion of the pulse modification apparatus and/or of at least one further pulse stretching apparatus and/or of at least one further pulse compression apparatus which results from an alteration of the at least one ambient parameter.

By virtue of this compensation, the emerging laser pulses have constant pulse properties independently of the at least one ambient parameter.

If, in addition to the pulse modification apparatus, the laser pulses also propagate through one or more further pulse stretching apparatuses and/or one or more further pulse compression apparatuses, the alteration of the dispersion of the further pulse stretching apparatus or of at least one of the plurality of further pulse stretching apparatuses and/or of the further pulse compression apparatus or of at least one of the plurality of further pulse compression apparatuses can also be compensated for instead of or in addition to the alteration of the dispersion of the pulse modification apparatus. One exemplary application is chirped pulse amplification systems. Preferably, the pulse modification apparatus is configured to compensate for the cumulated dispersion. The further pulse stretching and/or pulse compression apparatuses can be arranged upstream and/or downstream of the pulse modification apparatus in the beam path of the laser pulses.

The pulse modification apparatus is configured as a free-space device. In the case of free-space pulse stretching apparatuses and free-space pulse compression apparatuses, an alteration of the at least one ambient parameter leads in particular to an alteration of the refractive index of the air, or of the gas atmosphere, which in turn leads to an alteration of the dispersion.

The at least one dispersive optical element is for example at least one diffraction grating or at least one prism. The separated spectral components of the laser pulses have different propagation times before these are combined again, which leads to the desired temporal compression or temporal stretching of the laser pulses.

In the case of a single passive sensor element, the latter can exhibit an output variable change in the event of an alteration of only one ambient parameter or in the event of an alteration of a plurality of ambient parameters. In the case of a plurality of passive sensor elements, this correspondingly holds true for each of the passive sensor elements.

The passive conversion device converts the output variable change into a manipulated variable change, the manipulated variable change caused leading precisely to a compensation of the alteration of the dispersion which results from the alteration of the at least one ambient parameter.

A passive conversion device is understood here to mean in particular a conversion device which requires no active elements, i.e. for example no motor, no additional energy sources and no electronics. This correspondingly holds true for the passive sensor element. Consequently, the pulse modification apparatus is set up relatively simply and cost-effectively and is also simple to maintain or even maintenance-free.

In one embodiment, the actuating device comprises a plane-parallel transmissive optical element arranged such that the angle-separated spectral components of the laser pulses pass through said optical element and experience an incidence-angle-dependent parallel offset, the dispersion of the pulse modification apparatus being settable by way of a rotation of the plane-parallel transmissive optical element and the manipulated variable change corresponding to a rotation angle of the plane-parallel transmissive optical element. The plane-parallel transmissive optical element can be a glass lamina, for example. The rotation of the plane-parallel transmissive optical element by the rotation angle results in alteration of the beam path of the spectral components, which affects the dispersion of the pulse modification apparatus. Details concerning setting the dispersion by means of the rotation of the plane-parallel transmissive optical element may be found in EP 3 578 287 A1, the content of which is hereby incorporated in its entirety in the present application. In particular, the exact relationship between the rotation angle and the group delay dispersion is set out there.

The actuating device can alternatively also comprise a multi-wedge arrangement, in particular a double-wedge arrangement, which is arranged such that the angle-separated spectral components pass through this, the dispersion of the pulse modification apparatus being settable by way of a displacement of at least one wedge of the multi-wedge arrangement and/or a rotation of the multi-wedge arrangement. A double-wedge arrangement or multi-wedge arrangement is an optical arrangement comprising two or respectively more than two wedges. Wedges are understood here to mean wedge-shaped transmissive optical elements. In this case, the manipulated variable change is typically a displacement distance of the at least one wedge and/or a rotation angle of the multi-wedge arrangement. In particular, a thickness of a double-wedge arrangement can be varied by way of a displacement of a wedge of the double-wedge arrangement. This leads to a settability of the dispersion of the pulse modification apparatus since, upon passing through the double-wedge arrangement, the spectral components experience an incidence-angle-dependent beam offset that is dependent on the thickness of the double-wedge arrangement. Further details concerning setting the dispersion of a pulse stretching or pulse compression apparatus by means of such multi-wedge arrangements may likewise be found in EP 3 578 287 A1.

In a further embodiment, the output variable of the passive sensor element or of at least one of the passive sensor elements is a length. Length is understood here to mean the dimension of the passive sensor element or of part of the passive sensor element along an arbitrary spatial direction. Alternatively or additionally, the output variable can also be an orientation of the passive sensor element or of part of the passive sensor element. In particular, the output variable change can result in a displacement or a rotation or a superposition of a displacement and a rotation.

In a further embodiment, at least two of the passive sensor elements are connected in series with one another, as a result of which their output variable changes, in particular their length changes, are added together. By way of example, passive sensor elements can be connected in series with one another, these elements exhibiting an output variable change in the event of an alteration of the same ambient parameter. By virtue of the addition of the output variable changes, in particular the length changes, a given alteration of the ambient parameter results in a stronger signal, in particular in a greater mechanical travel. The passive conversion device manages with smaller levers. The signal-to-noise ratio becomes better. Overall, the compensation becomes more accurate and more reliable.

In a further embodiment, the passive conversion device is a mechanical gear mechanism, preferably a rod mechanism. A mechanical gear mechanism is a device for transmitting movements and forces by way of rigid components, for example gearwheels, toothed racks, chains, or belts. The passive conversion device can in particular also comprise a so-called transmission chain. A rod mechanism is a device comprising two or more rods which are connected to one another by way of joints or in a fixed manner, which device serves for transmitting forces and movements.

In one development of this embodiment, at least one joint of the mechanical gear mechanism or of the rod mechanism is a flexure. Flexures have the advantage of being frictionless or having extremely little friction. The output variable change can thus be converted more reliably and more accurately into the corresponding manipulated variable change, in particular into the rotation of the plane-parallel transmissive optical element by the corresponding rotation angle. The typically limited movement range of flexures is not a relevant limitation for the present application.

In a further embodiment, the passive conversion device is designed in accordance with an experimentally determined calibration curve which establishes a relation between the alteration of the at least one ambient parameter and the alteration of the dispersion of the pulse modification apparatus and/or of the at least one further pulse stretching apparatus and/or of the at least one further pulse compression apparatus. Such a calibration curve and the known relationship between the manipulated variable change, in particular the rotation angle, and the resultant adaptation of the dispersion give rise to a relationship between the alteration of the at least one ambient parameter and the value of the manipulated variable change which leads to the compensation of the alteration of the dispersion of the pulse modification apparatus.

In a further embodiment, the passive conversion device is designed in accordance with a mathematical relationship of the form

dβ₂=F(β₃,β₄, . . . ,βₘ,ω₀,dn)

between an alteration, dn, of a refractive index within the pulse modification apparatus and/or within the at least one further pulse stretching apparatus and/or within the at least one further pulse compression apparatus, which alteration results from the alteration of the at least one ambient parameter, and the resultant alteration, dβ₂, of the group delay dispersion and also the higher-order dispersion (β₃, β₄, . . . , βₘ) and the central frequency (ω₀) of the laser pulses (2) of the pulse modification apparatus. The inventors have discovered that in the case of pulse modification apparatuses in the form of free-space devices, the alteration of the group delay dispersion can be described approximately by way of mathematical relationships of the form indicated. A relationship between the alteration of the at least one ambient parameter and the alteration of the group delay dispersion then arises from a known relationship between the at least one ambient parameter and the refractive index, for example from the Edlén formula in the case of air. Since, furthermore, the relationship between the manipulated variable change, in particular the rotation angle of the plane-parallel transmissive optical element, and the alteration of the group delay dispersion is known, a relationship between the alteration of the at least one ambient parameter and the manipulated variable change leading to the compensation arises overall. A corresponding design of the passive conversion device allows a substantial or even complete compensation of the alteration of the dispersion, without the need to measure the pulse duration or some other pulse property.

In one development of this embodiment, the mathematical relationship is as follows: dβ₂=β₃ω₀dn. The mathematical relationship indicated describes the alteration of the group delay dispersion for a given alteration of the refractive index in many cases to at least a good approximation. Out of the higher orders of dispersion, only the third-order dispersion, δ₃, influences the mathematical relationship.

In a further embodiment, the manipulated variable change, in particular the rotation angle of the plane-parallel transmissive optical element, is at least approximately proportional to the output variable change, in particular to the length change, of the at least one passive sensor element. The alteration of the refractive index is, at least to a good approximation, typically proportional to the alteration of the at least one ambient parameter, for example in the case of the Edlén formula. The same applies to typical output variable changes, in particular length changes of passive sensor elements depending on the alteration of the at least one ambient parameter, and the alteration of the group delay dispersion depending on the manipulated variable change, in particular the rotation angle. Consequently, the passive conversion device should preferably be designed to cause a manipulated variable change which is proportional to the output variable change. In particular, the passive conversion device should preferably be designed to cause a rotation of the plane-parallel transmissive optical element by a rotation angle which is proportional to the length change or length changes of the passive sensor element or passive sensor elements. The relationships mentioned additionally give rise to the proportionality factor that leads to a compensation of the alteration of the dispersion.

In a further embodiment, the ambient parameter or one of the ambient parameters is an ambient pressure. The ambient pressure is weather-dependent, in particular, which means that it is subject to continual fluctuations. The ambient pressure has a relatively great influence on the refractive index, which means that it has a comparatively great effect on the dispersion of free-space devices. The compensation of alterations of the dispersion which result from an alteration of the ambient pressure is thus important.

In one development of this embodiment, the passive sensor element or at least one of the passive sensor elements comprises a pressure measuring cell, preferably an absolute pressure measuring cell. Pressure measuring cells typically comprise two interconnected membranes which deform in a manner dependent on pressure difference. In the case of absolute pressure measuring cells, the interspace between the membranes is evacuated. This has the advantage that these are insensitive to fluctuating ambient temperatures.

In a further embodiment, the ambient parameter or one of the ambient parameters is a temperature. An alteration of the temperature gives rise, firstly, to an alteration of the refractive index. Furthermore, however, a thermal expansion of components of the pulse modification apparatus, for example of one or more baseplates, may also occur. Moreover, the temperature can affect the grating period of diffraction gratings.

In one development of this embodiment, the passive sensor element or at least one of the passive sensor elements comprises a bimetallic element or a component part, in particular a rod, which has a greater coefficient of expansion than the component parts of the passive conversion device, in particular than the rods of the rod mechanism. In order to compensate for dispersion changes caused by thermal fluctuations, in particular pulse duration changes, materials having different coefficients of thermal expansion can be used in a targeted manner By way of example, at least one rod of the passive conversion device can be produced from Invar or titanium, which are distinguished by a very small coefficient of thermal expansion. The passive sensor element, by contrast, can comprise a rod composed of aluminium, for example, which exhibits a distinctly greater length change in the event of a temperature change.

The passive sensor element can for example also comprise a plate or some other component which is connected to a baseplate of the pulse modification apparatus and expands (or contracts) in the event of an alteration of the ambient temperature. Such an output variable change can for example result in a displacement of an articulation point of the rod mechanism, which results in an adaptation of the manipulated variable.

Bimetallic elements consist of two interconnected metal layers which differ in their coefficients of thermal expansion. In the event of a temperature change, therefore, bending of the bimetallic element occurs, and brings about the output variable change of the passive sensor element.

Both alterations of the ambient pressure and alterations of the ambient temperature can be compensated for by means of at least one passive sensor element in the form of at least one partly evacuated pressure cell. The pressure within the partly evacuated pressure measuring cell should be chosen suitably for this purpose. In order to attain the same mechanical travel for a given alteration of the ambient pressure, the use of partly evacuated pressure measuring cells necessitates a larger number of pressure measuring cells in comparison with the use of absolute pressure measuring cells.

In accordance with a further aspect of the invention, a chirped pulse amplification system for amplifying laser pulses comprises one or more pulse stretching apparatuses for dispersive stretching of the laser pulses, a pulse amplifying device for amplifying the stretched laser pulses, and one or more pulse compression apparatuses for dispersive compression of the amplified laser pulses, the pulse stretching apparatus or at least one of the pulse stretching apparatuses and/or the pulse compression apparatus or at least one of the pulse compression apparatuses being a pulse modification apparatus as described above. Unlike in conventional chirped pulse amplification systems, the pulse parameters of the emerging laser pulses in such a

chirped pulse amplification system remain constant independently of the at least one ambient parameter. In particular, the pulse duration of the emerging laser pulses can be kept constant even in the case of pressure fluctuations.

In principle, in order to stabilize the pulse properties, in particular the pulse duration, of the laser pulses of a chirped pulse amplification system, the distance between the dispersive optical elements can also be correctively tracked or readjusted. However, this is more complex and more expensive than compensation by way of the rotation of the plane-parallel transmissive optical element or by way of the displacement of the at least one wedge of the double-wedge arrangement.

Exemplary embodiments are illustrated in the schematic drawing and are explained below. In the figures, identical reference signs designate in each case identical or corresponding features.

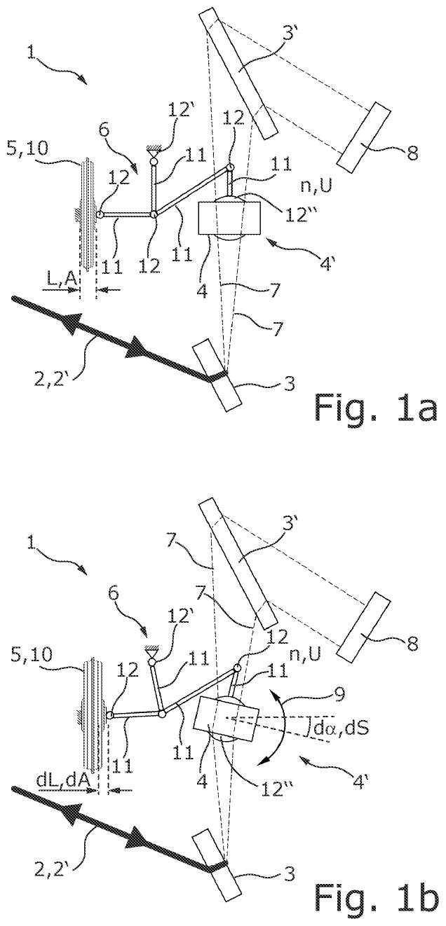

FIGS. 1a and b show one example of a pulse modification apparatus 1 in the form of a pulse compression apparatus for dispersive compression of laser pulses 2 comprising two dispersive optical elements 3, 3′, an actuating device 4′, a passive sensor element 5 and a passive conversion device 6.

The pulse modification apparatus 1 is a free-space device. The two dispersive optical elements 3, 3′ serve for angle separation and combination of the spectral components 7 of the laser pulses 2. Alternatively, however, the pulse modification apparatus 1 can also have just one or more than two dispersive optical elements 3, 3′. The dispersive optical elements 3, 3′ illustrated are diffraction gratings, but can also be other dispersive optical elements, for example prisms.

The arriving laser pulses 2, which are chirped, firstly impinge on the first dispersive optical element 3, whereby they are separated into their spectral components 7 and propagate in different directions. The spectral components 7 are parallelized by the second dispersive optical element 3′ and are subsequently reflected back by a reflective optical element 8. The reflective optical element 8 can be a deflection prism, for example. In this case, the spectral components 7 reflected back are offset in their level, such that the emerging laser pulses 2′ can easily be separated from the arriving laser pulses 2. The individual spectral components 7 have different propagation times in the pulse modification apparatus 1, which leads to the desired temporal compression of the laser pulses 2.

The actuating device 4′ illustrated comprises, by way of example, a plane-parallel transmissive optical element 4 arranged such that the angle-separated spectral components 7 of the laser pulses 2 pass through said optical element and experience an incidence-angle-dependent parallel offset. The dispersion of the pulse modification apparatus 1 is settable by way of a rotation 9 of the plane-parallel transmissive optical element 4. However, the actuating device 4′ can also be configured differently.

An output variable A of the passive sensor element 5 is dependent on an ambient parameter U. In the illustrated example, but not necessarily, the output variable A is the length L of the passive sensor element 5. In the event of an alteration of the ambient parameter U, the sensor element 5 thus exhibits an output variable change dA in the form of a length change dL.

The passive conversion device 6 serves for converting the output variable change dA of the passive sensor element 5 into a manipulated variable change dS of the actuating device 4′. In this case, the manipulated variable change dS brought about leads to a compensation of the alteration of the dispersion of the pulse modification apparatus 1 which results from the alteration of the ambient parameter U. In the example illustrated, the manipulated variable change dS corresponds to the rotation angle da of the plane-parallel transmissive optical element 4.

In contrast to the illustration here, the pulse modification device 1 can also have a plurality of passive sensor elements 5, the output variables A of which are dependent on the ambient parameter U. By way of example, at least two of the passive sensor elements 5 can also be connected in series with one another, as a result of which their output variable changes dA, in particular their length changes dL, are added together. Moreover, the output variables A of the passive sensor elements 5 can be dependent on a plurality of ambient parameters U. The output variable A of an individual sensor element 5 can also be dependent on a plurality of ambient parameters U, for example on the ambient pressure and the ambient temperature.

In the example illustrated, the ambient parameter U is the ambient pressure. The sensor element 5 comprises a pressure measuring cell 10 in the form of an absolute pressure measuring cell. A change in the ambient pressure gives rise to a deformation of membranes (not illustrated here) of the pressure measuring cell 10 which causes the length change dL of the sensor element 5. However, the sensor element 5 need not necessarily comprise a pressure measuring cell 10.

The ambient pressure affects in particular the refractive index n of the air or of a gas atmosphere of the pulse modification apparatus 1, whereby an alteration of the dispersion of the pulse modification apparatus 1 occurs indirectly.

The compensation of this dispersion change is explained by way of example hereinafter: FIG. 1a shows the pulse modification apparatus 1 under nominal pressure. The plane-parallel transmissive optical element 4 is on average perpendicular to the incident spectral components 7.

FIG. 1b shows the pulse modification apparatus 1 under a lower ambient pressure. The dispersion of the pulse modification apparatus 1 is increased and the propagation time needs to be shortened. The pressure measuring cell 10 expands owing to the lower ambient pressure. The sensor element 5 exhibits a length change dL; its length L is greater than in FIG. 1a. The sensor element 5 pushes on the passive conversion device 6 and rotates the plane-parallel transmissive optical element 4 by a rotation angle da, as a result of which the propagation time path length is shortened by way of the parallel offset such that the increase in the dispersion is compensated for.

Under an increased ambient pressure, the compensation takes place analogously. In this case, the dispersion in the pulse modification apparatus 1 decreases and the propagation time needs to be lengthened. The sensor element 5 pulls on the passive conversion device 6 and rotates the plane-parallel transmissive optical element 4 such that the propagation time lengthens on account of the parallel offset. In contrast to what is shown here, it is also possible for a plurality of pressure cells 10 to be connected in series with one another in order to further increase the mechanical travel.

In a departure from the example illustrated, the ambient parameter U or one of the ambient parameters U can also be a temperature. As a result of a temperature change, a thermal expansion of components of the pulse modification apparatus 1 can also occur besides an alteration of the refractive index n. In this case, the length change dL of the sensor element 5 or sensor elements 5 can be based on a thermal expansion of a material for example in the form of a rod. For this purpose, the material preferably has a large coefficient of thermal expansion. For example, the material can be aluminium. Alternatively or additionally, the sensor element 5 can also comprise a bimetallic element. Alterations of the dispersion of the pulse modification apparatus 1 which are caused by alterations of other ambient parameters U can also be compensated for.

In the example illustrated, the passive conversion device 6 is a mechanical gear mechanism, more precisely a rod mechanism, i.e. it has rods 11 connected to one another or to a baseplate via joints 12, 12′, here including a fixed bearing 12′. The plane-parallel transmissive optical element 4 is furthermore mounted rotatably by means of a joint 12″. The plane-parallel transmissive optical element 4 is arranged on the rotation axis. In the example shown, the passive conversion device 6 can be regarded as a mechanical lever system.

In FIGS. 1a and 1b, the joints 12, 12′ are flexures, but can also be other joints. Flexures have the advantage of being frictionless or having extremely little friction.

In contrast to the illustration here, the passive conversion device 6 need not be a mechanical gear mechanism, in particular need not be a rod mechanism. By way of example, the passive conversion device 6 can comprise a transmission chain. In this case, the passive conversion device 6 is a mechanical gear mechanism, but not a rod mechanism.

The passive conversion device 6 is configured, by way of example, such that the manipulated variable change dS in the form of the rotation angle da of the plane-parallel transmissive optical element 4 is at least approximately proportional to the output variable change dA in the form of the length change dL of the sensor element 5. This leads to a compensation of the alteration of the dispersion since, in the example shown, the length change dL and the alteration of the refractive index n are to a good approximation proportional to the alteration of the ambient parameter U and the alteration of the dispersion is proportional to the alteration of the refractive index n and the rotation angle da and, furthermore, the proportionality factor of the passive conversion device 6 between the length change dL and the rotation angle da is chosen accordingly.

In the example shown, the length change dL proportional to the alteration of the ambient parameter U is attributable to the pressure measuring cell 10 deforming proportionally to the alteration of the ambient pressure. Pressure fluctuations are thus converted into a proportional mechanical travel. The length L of the sensor element 5 is thus linearly dependent on the ambient pressure U. The plane-parallel transmissive optical element 4 is rotated proportionally to the alteration of the ambient pressure and keeps constant the pulse properties, in particular the pulse duration, of the emerging laser pulses 2′. Proportional output variable changes dA are additionally also attainable by means of other sensor elements 5 and for other ambient parameters U.

However, the manipulated variable change dS is not necessarily proportional to the output variable change dA of the sensor element 5. Generally, the passive conversion device can also be designed in accordance with a mathematical relationship of the form

dβ₂=F(β₃,β₄, . . . ,βₘ,ω₀,dn)

between an alteration, dn, of the refractive index n within the pulse modification apparatus 1, which alteration results from the alteration of the at least one ambient parameter U, and the resultant alteration, dβ₂, of the group delay dispersion, β₂, of the at least one pulse modification apparatus 1 and also the central frequency, ω₀, of the laser pulses 2 and the higher-order dispersion, β₃, β₄, . . . , βₘ, of the pulse modification apparatus 1. In particular, the mathematical relationship can be as follows: dβ₂=β₃ ω₀dn. In many cases, however, such mathematical relationships result in a manipulated variable change dS proportional to the output variable change dA, in particular in a rotation angle dα proportional to the length change dL. Alternatively, the passive conversion device 6 can be designed in accordance with an experimentally determined calibration curve which establishes a relation between the alteration of the at least one ambient parameter U and the alteration of the dispersion of the pulse modification apparatus 1.

In contrast to what is shown in FIGS. 1a and 1b, the pulse modification apparatus 1 can also be a pulse stretching apparatus for dispersive stretching of the laser pulses 2. In this case, the pulse modification apparatus 1, for the purpose of attaining a positive dispersion, can have two lenses, for example, in addition to the two dispersive optical elements 3, 3′.

The pulse modification apparatus 1 can also be configured to compensate for the alteration of the dispersion of at least one further pulse stretching and/or pulse compression apparatus (not illustrated here) which results from the alteration of the at least one ambient parameter U.

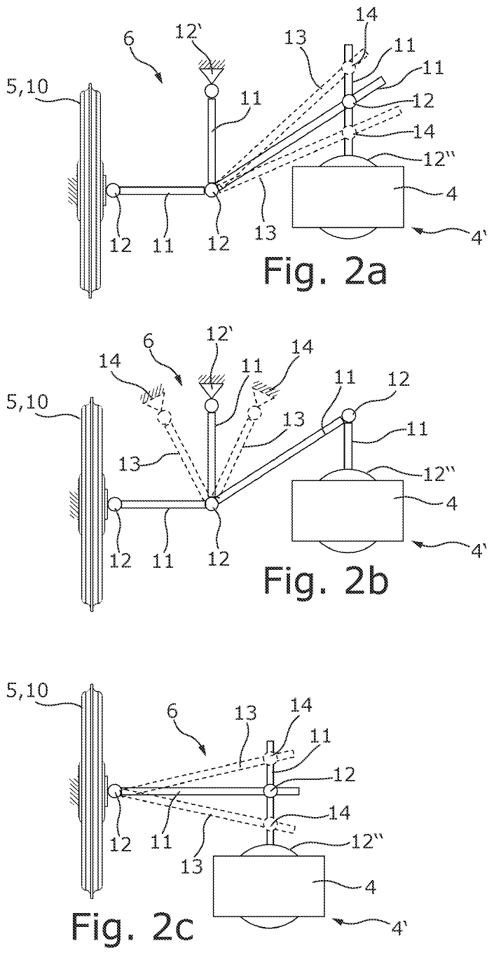

FIGS. 2a, 2b and 2c schematically illustrate variants of the passive conversion device 6 shown in FIGS. 1a and 1b. The sensor element 5 comprising the pressure measuring cell 10 and the plane-parallel transmissive optical element 4 are additionally shown.

The rods 13 and joints 14 depicted using dashed lines respectively correspond to two modified arrangements of the rods 11 and joints 12, 12′. Such modifications of the arrangement make it possible to set the attained rotation angle dα for a given length change dL of the sensor element 5. More generally, such modifications make it possible to set the attained manipulated variable change dS for a given output variable change dA.

In FIG. 2c, the passive conversion device 6 is furthermore constructed more simply and has only two rods 11.

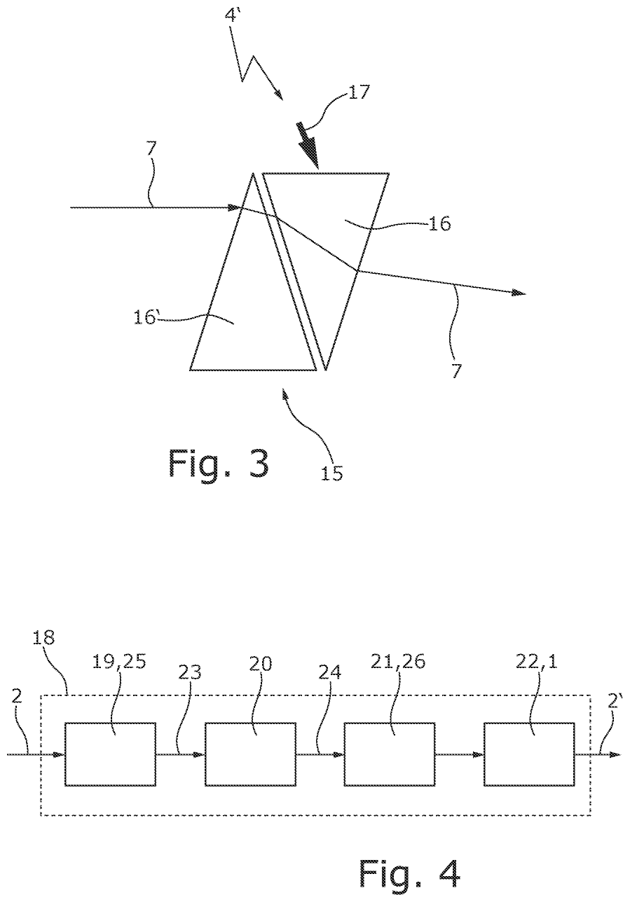

FIG. 3 schematically illustrates an actuating device 4′ comprising a double-wedge arrangement 15 having two wedges 16, 16′. The double-wedge arrangement 15 is arranged such that the angle-separated spectral components 7 of the laser pulses 2 pass through it. By way of a displacement 17 of one wedge 16 of the double-wedge arrangement 15, it is possible to set a thickness of the double-wedge arrangement 15 and thus the dispersion of the pulse modification apparatus 1 (not illustrated here). Instead of the double-wedge arrangement 15, the actuating device 4′ can also have a multi-wedge arrangement.

FIG. 4 schematically illustrates, in a simplified manner, one example of a chirped pulse amplification system 18 for amplifying laser pulses 2 comprising a pulse stretching apparatus 19, a pulse amplifying device 20 and a first pulse compression apparatus 21 and also a second pulse compression apparatus 22.

The arriving laser pulses 2 are temporally stretched by means of the pulse stretching apparatus 19. The stretched laser pulses 23 are subsequently amplified in the pulse amplifying device 20. The amplified laser pulses 24 are temporally compressed by means of the first pulse compression apparatus 21 and the second pulse compression apparatus 22 and the compressed laser pulses 2′ emerge from the chirped pulse amplification system 15.

The second pulse compression apparatus 22 is a pulse modification apparatus 1 configured as described above. In particular, this is a free-space device comprising an actuating device 4′, at least one passive sensor element 5 and a passive conversion device 6 for compensating for alterations of the dispersion of the pulse modification apparatus 1 which result from alterations of the at least one ambient parameter U. The pulse stretching apparatus 19 and the first pulse compression apparatus 21 here, by way of example, but not necessarily, are a further pulse stretching apparatus 25 and a further pulse compression apparatus 26, respectively, the dispersion alterations of which are likewise compensated for in the pulse modification apparatus 1.

In a departure from the example illustrated here, the chirped pulse amplification system 15 can also have more than one pulse stretching apparatus and/or only one or more than two pulse compression apparatuses. Moreover, the pulse stretching apparatus 19 can be a pulse modification apparatus 1 configured as described above.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A pulse modification apparatus for dispersive stretching or compression of laser pulses, the pulse modification apparatus comprising:
at least one dispersive optical element for angle separation and combination of spectral components of laser pulses,
an actuator for setting a dispersion of the pulse modification device by influencing the spectral components of the laser pulses,
at least one passive sensor having an output variable dependent on at least one ambient parameter, and
a passive converter for converting a change of the output variable of the at least one passive sensor into a manipulated variable change of the actuator in order to compensate for an alteration of the dispersion of the pulse modification apparatus resulted from an alteration of the at least one ambient parameter.

2. The pulse modification apparatus according to claim 1, wherein the actuator comprises a plane-parallel transmissive optical element arranged such that the angle-separated spectral components of the laser pulses pass through the plane-parallel transmissive optical element and experience an incidence-angle-dependent parallel offset, the dispersion of the pulse modification apparatus being settable by a rotation of the plane-parallel transmissive optical element, and the manipulated variable change corresponding to a rotation angle of the plane-parallel transmissive optical element.

3. The pulse modification apparatus according to claim 2, wherein the output variable of the passive sensor is a length of the passive sensor.

4. The pulse modification apparatus according to claim 1, wherein the at least one passive sensor comprises at least two passive sensors connected in series with one another, and wherein changes of the output variables of the at least two passive sensors are added together.

5. The pulse modification apparatus according to claim 1, wherein the passive converter comprises a mechanical gear mechanism.

6. The pulse modification apparatus according to claim 5, wherein the mechanical gear mechanism comprises a rod mechanism.

7. The pulse modification apparatus according to claim 5, wherein at least one joint of the mechanical gear mechanism is a flexure.

8. The pulse modification apparatus according to claim 1, wherein the passive converter is configured in accordance with an experimentally determined calibration curve, which establishes a relation between the alteration of the at least one ambient parameter and the alteration of the dispersion of the pulse modification apparatus.

9. The pulse modification apparatus according to claim 1, wherein the passive converter is configured in accordance with a mathematical relationship of a form
dβ₂=F(β₃,β₄, . . . ,βₘ,ω₀,dn)
wherein dn is an alteration of a refractive index within the pulse modification apparatus, which results from the alteration of the at least one ambient parameter, β₂ is a group delay dispersion, β₃, β₄, . . . , βₘ are higher-order dispersions, and ω₀ is a central frequency of the laser pulses, and wherein the alternation of the dispersion of the pulse modification apparatus comprises an alternation of the group delay dispersion dβ₂.

10. The pulse modification apparatus according to claim 9, wherein the mathematical relationship is as follows:
dβ₂=β₃ω₀dn

11. The pulse modification apparatus according to claim 3, wherein the rotation angle of the plane-parallel transmissive optical element is approximately proportional to a change of the length of the at least one passive sensor element.

12. The pulse modification apparatus according to claim 1, wherein the at least one ambient parameter is an ambient pressure.

13. The pulse modification apparatus according to claim 12, wherein the at least one passive sensor comprises a pressure measuring cell.

14. The pulse modification apparatus according to claim 1, wherein the at least one ambient parameter is a temperature.

15. The pulse modification apparatus according to claim 14, wherein the at least one passive sensor comprises a bimetallic element or a component part, which has a greater coefficient of expansion than component parts of the passive converter.

16. A chirped pulse amplification system for amplifying laser pulses, the chirped pulse amplification system comprising:
one or more pulse stretching apparatuses for dispersive stretching of the laser pulses,
a pulse amplifying device for amplifying the stretched laser pulses, and
one or more pulse compression apparatuses for dispersive compression of the amplified laser pulses, at least one of the pulse stretching apparatuses or at least one of the pulse compression apparatuses being a pulse modification apparatus according to claim 1.
